(19) United States
(12) Patent Application Publication
(10) Pub. No.: US 2021/0332512 A1
(43) Pub. Date: Oct. 28, 2021

(54) WIPE AND MANUFACTURING METHOD THEREOF

(71) Applicant: XIAMEN YANJAN NEW MATERIAL CO., LTD., Xiamen, Fujian (CN)

(72) Inventors: Qingzhong Zheng, Xiamen (CN); Shunxin He, Xiamen (CN); Danpin Wu, Xiamen (CN); Jihua Xie, Xiamen (CN)

(21) Appl. No.: 17/262,208

(22) PCT Filed: May 17, 2019
(86) PCT No.: PCT/CN2019/087400

§ 371 Date: Jan. 22, 2021

(30) Foreign Application Priority Data
Jan. 15, 2019 (CN) 201910036114.4

(51) Int. Cl. D04H 1/56; D04H 1/593

(52) U.S. Cl. CPC D04H 1/565; D04H 1/593

(57) ABSTRACT

A wipe and a manufacturing method are disclosed. Upper and lower layers of the wipe are melt-blown fiber webs, and an intermediate layer thereof is a wood pulp fiber web, wherein an adhesive is attached to the surfaces of the melt-blown fiber webs, and melt-blown fibers of the melt-blown fiber webs are interwoven in the wood pulp fiber web. When in use, fuzz and pilling of the melt-blown fibers on the surfaces caused by friction are prevented, and the wood pulp short fibers in the intermediate layer is also further prevented from falling out to cause “Tinting” during use.

### BACKGROUND OF THE INVENTION

### 1. Field of the Invention

The present invention relates to a wipe, and more particularly to a wipe for personal hygiene and baby care, which can prevent its surface from fuzzing and pilling A manufacturing method for the wipe is also disclosed.

### 2. Description of the Prior Art

Since wipes are convenient to carry, store and use, they are popular among consumers. Wipes are often used in our daily life when, for example, parents change babies' diapers, people have meals in restaurants, or people do skincare. It can be seen that wipes have increasingly extensive use in particularly personal hygiene and baby care.

A wipe may be a spunlace non-woven product or spunbond non-woven product. Compared with a conventional cloth wipe, its manufacturing method is easy, the price is low, and the wipe can be used in a dry or wet manner. For improving wipes in terms of moisture absorption and water absorption, a common solution is to add wood pulp during production of wipe products in order to make wipes more effective in moisture absorption and cleaning. However, wood pulp fibers are natural short fibers, which are only retained by performing a spunbonding or spunlace processes. When in use, the wood pulp short fibers are easy to fall off after repeated friction, causing linting to affect the service life.

### SUMMARY OF THE INVENTION

In order to overcome the defects of the conventional product and its manufacturing method, the objective of the present invention is to provide a wipe that can prevent its surface from fuzzing and pilling. For achieving the foregoing objective, the present invention implements the following technical schemes.

A wipe comprises upper and lower layers of melt-blown fiber webs and an intermediate layer of a wood pulp fiber web. An adhesive is attached to respective surfaces of the melt-blown fiber webs. Melt-blown fibers of the melt-blown fiber webs are woven into the wood pulp fiber web.

The melt-blown fiber webs contain one-component melt-blown fibers each having a high-melting-point resin at its surface, melt-blown fibers each having a low-melting-point resin at its surface, or blend fibers of the two.

The high-melting-point resin and the low-melting-point resin have a melting-point difference therebetween of ≥20° C.

The melt-blown fibers each having the low-melting-point resin at its surface are one-component melt-blown fibers, two-component melt-blown fibers, or a blend of the two.

The two-component melt-blown fibers are two-component skin-core melt-blown fibers, two-component segmented-pie melt-blown fibers, or two-component side-by-side melt-blown fibers.

The adhesive is hot-melt adhesive or solvent adhesive.

A weight percentage of the wood pulp fiber web in the wipe is greater than 65 wt %.

The wood pulp fiber web contains a hot-melt adhesive substance.

The hot-melt adhesive substance is polyester fibers having a low-melting-point, ES short fibers, two-component spunbond long fibers or a blend thereof.

A manufacturing method for the foregoing wipe, comprising steps of:

(1) opening and scattering wood pulp using an opening roller, and forming the wood pulp fiber web using a blowing nozzle in the presence of an auxiliary air stream;

(2) performing a melt blowing process involving heating and melting a thermoplastic resin; dispersing melt streams of the thermoplastic resin that have been extruded from spinneret plates into fiber bundles having a diameter of ≤10 μm using a high-temperature, high-speed hot air stream, thereby forming the melt-blown fiber webs in the presence of the hot air stream; and joining the melt-blown fiber webs with two side surfaces of the wood pulp fiber web, so as to form a multi-layer fiber web having the melt-blown fiber webs at its two sides and having the wood pulp fiber web in its middle;

(3) binding the fiber webs in the multi-layer fiber web together using a heating device, so as to form the wipe having the upper and lower layers of the melt-blown fiber webs and having the intermediate layer of the wood pulp fiber web;

(4) after the wipe is formed in the step (3), coating two sides of the wipe with an adhesive by performing a roll coating process using a pair of coating rollers, thereby forming the wipe having the adhesive attached to its surfaces and having the upper and lower layers of the melt-blown fiber webs and having the intermediate layer of the wood pulp fiber web.

In the step (2), heating and melting two thermoplastic resins having a melting-point difference therebetween of ≥20° C.; dispersing melt streams of the thermoplastic resins that have been extruded from the spinneret plates into the fiber bundles having a diameter of ≤10 μm using the high-temperature, high-speed hot air stream, in which the melt-blown fiber webs contain melt-blown fibers each having a high-melting-point resin at its surface, melt-blown fibers each having a low-melting-point resin at its surface, or blend fibers of the two.

The spinneret plates have two-component spinneret orifices.

The two-component spinneret orifices are arranged in a skin-core form, a segmented-pie form, or a side-by-side form.

The heating device is a hot air oven, a hot rolling roller or a combination thereof.

In the step (1), mixing the wood pulp that has been opened and scattered by the opening roller with a hot-melt adhesive substance into a mixture, and blowing the mixture using the blowing nozzle in the presence of the auxiliary air stream to form the wood pulp fiber web containing the hot-melt adhesive substance.

By adopting the aforementioned technical schemes, the present invention provides a wipe made using the manufacturing method. Since the fibers of the melt-blown fiber webs of the wipe of the present invention are densely arranged, it effectively prevents the wood pulp short fibers in the intermediate layer from falling Besides, the adhesive is attached to the surfaces of the melt-blown fiber webs, an adhesive film is formed on each of the surfaces of the melt-blown fiber webs, such that when in use, fuzz and pilling of the melt-blown fibers on the surfaces caused by friction are prevented, and the wood pulp short fibers in the intermediate layer is also further prevented from falling out to cause “Tinting” during use.

### BRIEF DESCRIPTION OF THE DRAWINGS

FIG. 1 is a schematic drawing illustrating manufacturing of a wipe according to Embodiment 1 of the present invention;

FIG. 2 is a cross-sectional view of the wipe according to Embodiment 1 of the present invention;

FIG. 3 is a cross-sectional view of a wipe according to Embodiment 2 of the present invention;

FIG. 4A is a cut-away view of a skin-core melt-blown fiber according to the present invention;

FIG. 4B is a cut-away view of a two-component side-by-side melt-blown fiber according to the present invention;

FIG. 4C is a cut-away view of a two-component segmented-pie melt-blown fiber according to the present invention;

FIG. 5 is a schematic drawing illustrating manufacturing of a wipe according to Embodiment 3 of the present invention; and

FIG. 6 is a cross-sectional view of the wipe according to Embodiment 3 of the present invention.

### DETAILED DESCRIPTION OF THE PREFERRED EMBODIMENTS

For further illustrating the technical schemes of the present invention, the following detailed description of the present invention will be made with reference to particular embodiments

### Embodiment 1

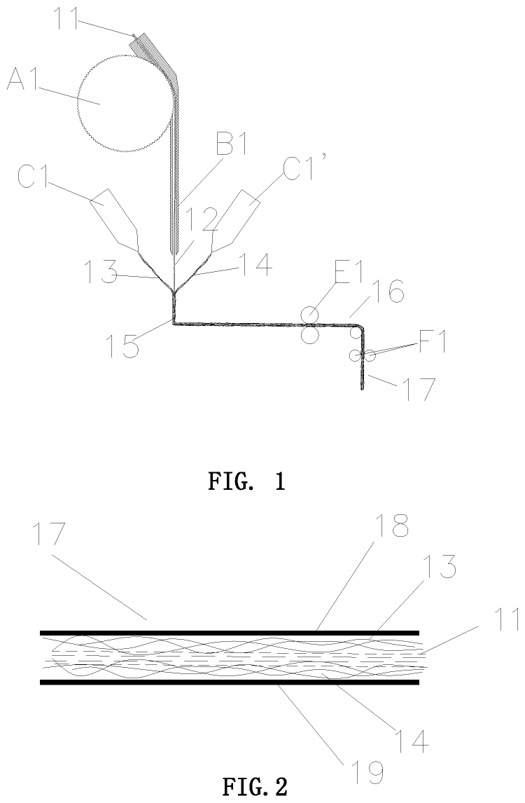

As shown in FIG. 1, the present invention discloses a manufacturing method for a wipe, comprising the following steps:

(1) opening and scattering wood pulp 11 using an opening roller A1, and forming a wood pulp fiber web 12 using a blowing nozzle B1 in the presence of an auxiliary air stream;

(2) performing a melt blowing process involving heating and melting a thermoplastic resin; dispersing melt streams of the thermoplastic resin that have been extruded from spinneret plates C1, C1′ into fiber bundles having a diameter of ≤10 μm using a high-temperature, high-speed hot air stream, thereby forming melt-blown fiber webs 13, 14 in the presence of the hot air stream; and joining the melt-blown fiber webs 13, 14 with two side surfaces of the wood pulp fiber web 12, so as to form a multi-layer fiber web 15 having the melt-blown fiber webs 13, 14 at its two sides and having the wood pulp fiber web 12 in its middle. The melt-blown fiber webs 13, 14 may contain one-component melt-blown fibers each having a high-melting-point resin at its surface;

(3) binding the fiber webs in the multi-layer fiber web 15 together using a pair of hot rolling rollers E1 that engage with each other, so as to form a wipe 16 having the upper and lower layers of the melt-blown fiber webs 13, 14 and having the intermediate layer of the wood pulp fiber web 12;

(4) coating two sides of the wipe 16 with an adhesive by performing a roll coating process using a pair of coating rollers F1, thereby forming a wipe 17 having the adhesive attached to its surfaces and having the upper and lower layers of the melt-blown fiber webs 13, 14 and having the intermediate layer of the wood pulp fiber web 12. A weight percentage of the wood pulp fiber web 12 in the wipe is 70 wt %.

As shown in FIG. 2, the present invention further discloses a wipe made using the foregoing manufacturing method. The wipe has a laminated structure. The wipe 17 comprises upper and lower layers of melt-blown fiber webs 13, 14 and an intermediate layer of a wood pulp fiber web 12.

Melt-blown fibers of the melt-blown fiber webs 13, 14 are woven into the wood pulp fiber web 12. An adhesive is attached to the surfaces of the melt-blown fiber webs 13, 14. The adhesive is hot-melt adhesive or solvent adhesive.

Therefore, since the adhesive is attached to the surfaces of the melt-blown fiber webs 13, 14, an adhesive film 18, 19 is formed on each of the surfaces of the melt-blown fiber webs 13, 14, such that when in use, fuzz and pilling of the melt-blown fibers on the surfaces caused by friction are prevented, and the wood pulp short fibers in the intermediate layer is also further prevented from falling out to cause “linting” during use.

### Embodiment 2

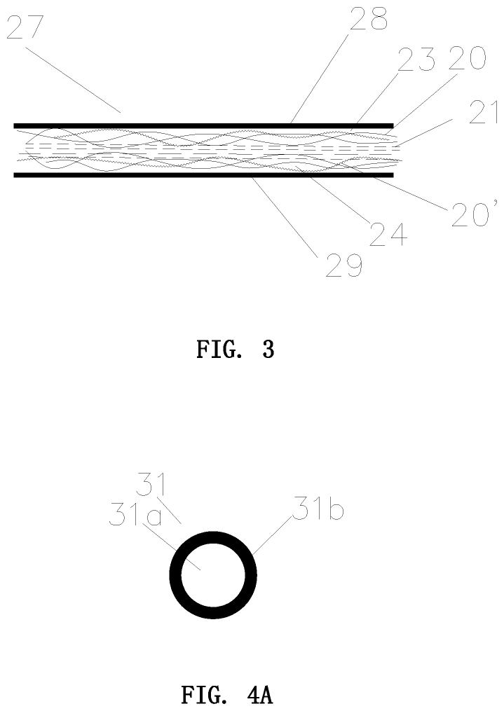

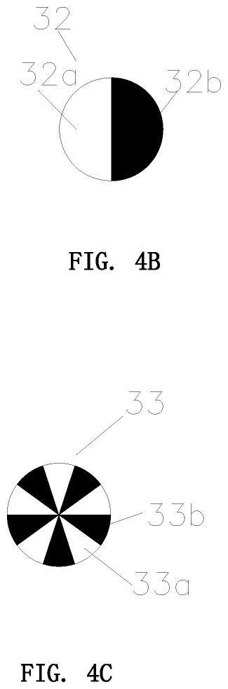

As shown in FIG. 3, the present invention discloses a wipe 27, which has a laminated structure. The wipe 27 comprises upper and lower layers of melt-blown fiber webs 23, 24 and an intermediate layer of a wood pulp fiber web 21. An adhesive 28, 29 is attached to the surfaces of the melt-blown fiber webs 23, 24. Melt-blown fibers of the melt-blown fiber webs 23, 24 are woven into the wood pulp fiber web 21. The melt-blown fiber webs 23, 24 contain one-component melt-blown fibers 20 each having a high-melting-point resin at its surface, melt-blown fibers 20′ each having a low-melting-point resin at its surface, or blend fibers of the two. The melt-blown fibers 20′ each having a low-melting-point resin at its surface may be one-component melt-blown fibers, two-component melt-blown fibers, or a blend of the two. The two-component melt-blown fibers may be skin-core melt-blown fibers 31, two-component segmented-pie melt-blown fibers 33, or two-component side-by-side melt-blown fibers 32. As shown in FIG. 4A through FIG. 4C, the skin-core melt-blown fiber 31, its skin layer resin 31b has a melting point lower than a melting point of its core layer resin 31a. For the two-component segmented-pie melt-blown fiber 33 and two-component side-by-side melt-blown fiber 32, one of their constituent resin 32b, 33b has a melting point lower than a melting point of the other constituent resin 32a, 33a. The two-component melt-blown fibers are made by heating and melting two thermoplastic resins having a melting-point difference therebetween of ≥20° C., and blowing into fibers through two-component spinneret orifices provided on the spinneret plates.

Therefore, since the melt-blown fiber webs 23, 24 contain the melt-blown fibers 20′ each having a low-melting-point resin at its surface, when the low-melting-point resin in the melt-blown fibers is melted in a hot air oven, the fibers are bound together. This not only enhances the overall strength of the resulting wipe, but also leads to a dense arrangement of the melt-blown fibers, while endowing the adhesive 28, 29 attached to the surfaces of the melt-blown fiber webs 23, 24 with improved adhesion. Consequently, the resulting wipe is more wear resistant, and unlikely to pill and fuzz.

### Embodiment 3

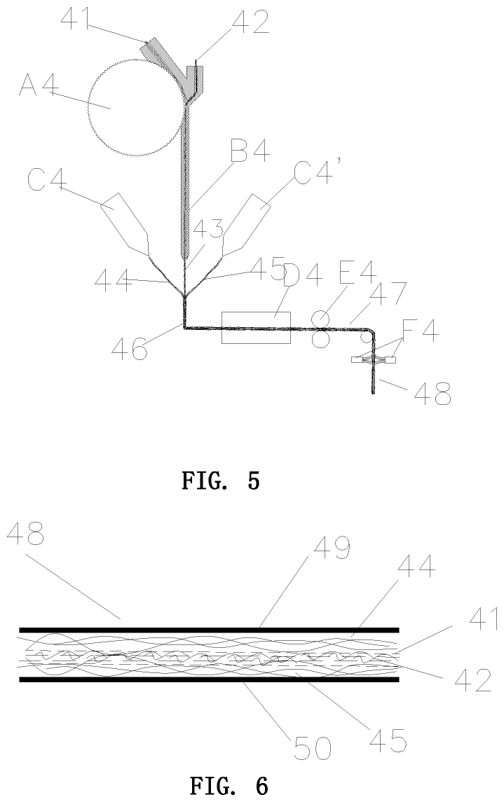

As shown in FIG. 5, the present invention discloses a manufacturing method for a wipe, comprising the following steps:

(1) mixing wood pulp 41 that has been opened and scattered by an opening roller A4 with a hot-melt adhesive substance 42 into a mixture, and blowing the mixture using a blowing nozzle B4 in the presence of an auxiliary air stream to form a wood pulp fiber web 43 containing the hot-melt adhesive substance 42;

(2) performing a melt blowing process involving heating and melting a thermoplastic resin to flow into a spinning box; in the spinning box, dispersing melt streams of the thermoplastic resin that have been extruded from spinneret plates C4, C4′ into fiber bundles having a diameter of ≤10 μm using a high-temperature, high-speed hot air stream, thereby forming melt-blown fiber webs 44, 45 in the presence of the hot air stream; and joining the melt-blown fiber webs 44, 45 with two side surfaces of the wood pulp fiber web 43 containing the hot-melt adhesive substance 42, so as to form a multi-layer fiber web 46 having the melt-blown fiber webs 44, 45 at its two sides and having the wood pulp fiber web 43 containing the hot-melt adhesive substance 42 in its middle;

(3) binding the fiber webs in the multi-layer fiber web 46 together using a hot air oven D4 and a pair of hot rolling rollers E4 that engage with each other, so as to form a wipe 47 having the upper and lower layers of the melt-blown fiber webs 44, 45 and having the intermediate layer of the wood pulp fiber web 43 containing the hot-melt adhesive substance 42;

(4) coating two sides of the wipe 47 with an adhesive using a coating device F4, thereby forming a wipe 48 having the adhesive attached to its surfaces and having the upper and lower layers of the melt-blown fiber webs 44, 45 and having the intermediate layer of having the wood pulp fiber web 43 containing the hot-melt adhesive substance 42.

As shown in FIG. 6, the present invention discloses a wipe made using the foregoing manufacturing method. The wipe has a laminated structure. The wipe 47 comprises upper and lower layers of melt-blown fiber webs 44, 45 and an intermediate layer of a wood pulp fiber web 43. Melt-blown fibers of the melt-blown fiber webs 44, 45 are woven into the wood pulp fiber web 43. An adhesive is attached to the surfaces of the melt-blown fiber webs 44, 45. The wood pulp fiber web 43 contains a hot-melt adhesive substance 42. The hot-melt adhesive substance 42 may be polyester fibers having a low-melting-point, ES short fibers, two-component spunbond long fibers or a blend thereof. The blend refers to a blend of two or all of polyester fibers having a low-melting-point, ES short fibers and two-component spunbond long fibers. The melt-blown fiber webs 44, 45 may contain melt-blown fibers each having a low-melting-point resin at its surface.

Therefore, since the adhesive is attached to the surfaces of the melt-blown fiber webs 44, 45, an adhesive film 49, 50 is formed on each of the surfaces of the melt-blown fiber webs 44, 45, such that when in use, fuzz and pilling of the melt-blown fibers on the surfaces caused by friction are prevented, and the wood pulp short fibers in the intermediate layer is also further prevented from falling out to cause “linting” during use. Besides, the intermediate layer of the wood pulp fiber web contains the hot-melt adhesive substance 42. The surface of the hot-melt adhesive substance 42 will melt in the hot air oven D4. In a certain extent, the wood pulp short fibers of the intermediate layer are retained, making it difficult for the wood pulp short fibers to move. The wood pulp short fibers in the intermediate layer are also further prevented from falling out to cause “linting” during use, so as to increase the abrasion resistance of the wipe.

What is claimed is:

1. A wipe, comprising upper and lower layers of melt-blown fiber webs and an intermediate layer of a wood pulp fiber web, wherein an adhesive is attached to respective surfaces of the melt-blown fiber webs, melt-blown fibers of the melt-blown fiber webs are woven into the wood pulp fiber web.

2. The wipe of claim 1, wherein the melt-blown fiber webs contains one-component melt-blown fibers each having a high-melting-point resin at its surface, melt-blown fibers each having a low-melting-point resin at its surface, or blend fibers of the two.

3. The wipe of claim 2, wherein the high-melting-point resin and the low-melting-point resin have a melting-point difference therebetween of ≥20° C.

4. The wipe of claim 2, wherein the melt-blown fibers each having the low-melting-point resin at its surface are one-component melt-blown fibers, two-component melt-blown fibers, or a blend of the two.

5. The wipe of claim 4, wherein the two-component melt-blown fibers are two-component skin-core melt-blown fibers, two-component segmented-pie melt-blown fibers, or two-component side-by-side melt-blown fibers.

6. The wipe of claim 1, wherein the adhesive is hot-melt adhesive or solvent adhesive.

7. The wipe of claim 1, wherein a weight percentage of the wood pulp fiber web in the wipe is greater than 50 wt %.

8. The wipe of claim 1, wherein a weight percentage of the wood pulp fiber web in the wipe is 65 wt %-80 wt %.

9. The wipe of claim 1, wherein the wood pulp fiber web contains a hot-melt adhesive substance.

10. The wipe of claim 9, wherein the hot-melt adhesive substance is polyester fibers having a low-melting-point, ES short fibers, two-component spunbond long fibers or a blend thereof.

11. A manufacturing method for the wipe of claim 1, comprising steps of:
(1) opening and scattering wood pulp using an opening roller, and forming the wood pulp fiber web using a blowing nozzle in the presence of an auxiliary air stream;
(2) performing a melt blowing process involving heating and melting a thermoplastic resin; dispersing melt streams of the thermoplastic resin that have been extruded from spinneret plates into fiber bundles having a diameter of ≤10 μm using a high-temperature, high-speed hot air stream, thereby forming the melt-blown fiber webs in the presence of the hot air stream; and joining the melt-blown fiber webs with two side surfaces of the wood pulp fiber web, so as to form a multi-layer fiber web having the melt-blown fiber webs at its two sides and having the wood pulp fiber web in its middle;
(3) binding the fiber webs in the multi-layer fiber web together using a heating device, so as to form the wipe having the upper and lower layers of the melt-blown fiber webs and having the intermediate layer of the wood pulp fiber web;
(4) after the wipe is formed in the step (3), coating two sides of the wipe with an adhesive by performing a roll coating process using a pair of coating rollers, thereby forming the wipe having the adhesive attached to its surfaces and having the upper and lower layers of the melt-blown fiber webs and having the intermediate layer of the wood pulp fiber web.

12. The manufacturing method of claim 11, in the step (2), heating and melting two thermoplastic resins having a melting-point difference therebetween of ≥20° C.; dispersing melt streams of the thermoplastic resins that have been extruded from the spinneret plates into the fiber bundles having a diameter of ≤10 μm using the high-temperature, high-speed hot air stream, in which the melt-blown fiber webs contain melt-blown fibers each having a high-melting-point resin at its surface, melt-blown fibers each having a low-melting-point resin at its surface, or blend fibers of the two.

13. The manufacturing method of claim 11, wherein the spinneret plates have two-component spinneret orifices.

14. The manufacturing method of claim 11, wherein the two-component spinneret orifices are arranged in a skin-core form, a segmented-pie form, or a side-by-side form.

15. The manufacturing method of claim 11, wherein the heating device is a hot air oven, a hot rolling roller or a combination thereof.

16. The manufacturing method of claim 11, in the step (1), mixing the wood pulp that has been opened and scattered by the opening roller with a hot-melt adhesive substance into a mixture, and blowing the mixture using the blowing nozzle in the presence of the auxiliary air stream to form the wood pulp fiber web containing the hot-melt adhesive substance.
